(19) United States
(12) Patent Application Publication
(10) Pub. No.: US 2026/0202102 A1
(43) Pub. Date: Jul. 16, 2026

(54) HEAT TRANSFER COMPOSITIONS, METHODS AND SYSTEMS

(71) Applicant: Solstice Advanced Materials US, Inc., Morris Plains, NJ (US)

(72) Inventors: Bruno Yuji Kimura de Carvalho, Morris Plains, NJ (US); Nitin Karwa, Morris Plains, NJ (US); Nilesh Purohit, Morris Plains, NJ (US); Ryan J. Hulse, Morris Plains, NJ (US)

(21) Appl. No.: 19/450,062

(22) Filed: Jan. 15, 2026

Related U.S. Application Data
(60) Provisional application No. 63/745,337, filed on Jan. 15, 2025.

(51) Int. Cl. F25B 9/00; C09K 5/04; C10M 171/00

(52) U.S. Cl. CPC F25B 9/006; C09K 5/045; C10M 171/008; F25B 2400/12

(57) ABSTRACT

The present invention relates refrigerants which include HFO-1132(E), HFC-161, and R-290, and the use of such refrigerants in high transfer applications.

### CROSS REFERENCE TO RELATED APPLICATIONS

The present application claims the priority benefit of U.S. Provisional Application No. 63/745,337 filed Jan. 15, 2025, which is incorporated herein by reference in its entirety.

### FIELD OF THE INVENTION

This invention relates to compositions, methods and systems having utility in heat transfer applications generally, with particular benefit in heat pump applications, and in particular aspects to heat transfer and/or refrigerant compositions for replacement of or use instead of previously used refrigerants, including propane (also known as R-290).

### BACKGROUND

Closed cycle refrigeration systems are well known and are typically used for many applications requiring heating and/or cooling, including commercial refrigeration, air conditioning units, heat pumps, residential and commercial heating, mini-split systems and the like. Such systems use a refrigerant which can absorb surrounding heat while passing through an evaporator causing evaporation of the liquid refrigerant to a vapor. After the refrigerant has absorbed heat in the evaporator, it is compressed thereby increasing its pressure. The high-pressure refrigerant fluid is passed through a condensing unit, typically located outside the refrigerated space. The heat in the refrigerant is given up to a fluid or body that absorbs the heat. Many heat absorbing fluids can be used, including ambient air and/or water or other liquid coolant. In the condenser, the refrigerant vapor returns to its liquid state. It is then expanded through an expansion device, such as throttle, valve or capillary tube, to a low-pressure fluid and is then returned to the evaporator to begin the cycle again.

Many different types of refrigerants have been utilized for vapor compression refrigeration systems. While many hydrofluorcarbons (HFCs) have been used as refrigerants, such as HFC-134a, the desire to use refrigerants with low global warming potentials (GWPs) has made many HFCs disfavored.

Hydrocarbon refrigerants, while usually classified as A3 refrigerants according to the ISO817 Standard, nevertheless generally have the desirable feature of having very low GWPs. For example, propane has a very low GWP (under AR4) of 3. However, since hydrocarbons such as propane are A3, and thus flammable, the amount of refrigerant that can be contained in a closed vapor compression system (referred to as the “charge” of refrigerant) is restricted. For example, as described in U.S. Pat. No. 12,111,085, the current charge limit for R-290 is 150 μm (5.3 oz) in the United States. This charge restriction typically limits the amount of heat transfer, i.e., the capacity, that can be achieved using the refrigerant, and as a result hydrocarbons such as propane are not considered desirable in many applications due to this charge limit restriction. While it may be possible to overcome this charge limit difficulty associated with propane by using a multi-circuit system to increase capacity, this has the highly disadvantageous effect of drastically increasing the capital cost and operating/maintenance costs of the system.

Another disadvantage of hydrocarbon refrigerants such as propane is the limited ability to provide sufficient heating capacity at low ambient temperature conditions (e.g., less than about-15° C.).

Applicants have thus come to appreciate the need for an alternative A3 refrigerant which at once has: a low GWP (e.g., less than 50 (under AR4)); a capacity substantially higher than propane (e.g., at least 120% relative to the capacity of propane); an efficiency that is high compared to the efficiency of propane (e.g., at least 97%); a relatively low boiling temperature (e.g., less than about −50° C.); and a low glide (e.g., less than about 2° C.) in the evaporator and/or condenser of the refrigeration system.

Applicants have also come to appreciate that such a refrigerant can be especially advantageous for use in heat pumps, which are typically used to upgrade low-grade thermal energy, such as that derived from a heat source (such as for example, air, soil, surface water or underground water, geothermal energy, solar energy, and industrial exhaust heat and process streams), to high-grade thermal energy via transferring heat to a heat sink in the condenser. Heat pump systems use a working fluid, i.e., a refrigerant, to facilitate the generation and transfer of heat over a vapor compression thermodynamic cycle. Heat pump systems have been designed with a reversing valve so they can be used for both heating and cooling purposes.

Applicants have also come to appreciate that the new refrigerants as described herein, due in large part to the high relative capacity, can prove a substantial and significant cost savings in new systems due to the ability to purchase for the system a total compressor displacement that is substantially smaller (e.g., at least 15% smaller) than used in prior hydrocarbon systems, such as propane system, which thus afford in such situations a substantial savings in installed cost and potentially maintenance costs over the life of the installation.

These and/or other needs are satisfied by the inventive refrigerants, systems and methods described in detail herein.

### SUMMARY

Applicants have unexpectedly and advantageously found, as described in detail herein, that compositions based on carefully selected amounts of the combination of HFO-1132(E), R-290 and HFC-161 can provide refrigerants that satisfy many, and preferably all, of the requirements discussed above, as well additional requirements and/or advantages as described herein.

Applicants have discovered refrigerants, heat transfer compositions, refrigeration methods and systems, which utilize one or more of the compositions of the present invention as a refrigerant, including and especially in connection with heat pump applications. Including mini-split systems.

The present invention includes refrigerants comprising:
(1) from about 16% to about 35% by weight of HFO-1132(E);
(2) from about 32% to about 52% by weight of HFC-161; and
(3) from about 18% to about 50% by weight of R-290,
(4) wherein said refrigerant has (i) a Global Warming Potential (GWP) of 10 or less.
   The refrigerant according to this paragraph is sometimes referred to herein for convenience as Refrigerant 1A.

The present invention includes refrigerants consisting essentially of:
(1) from about 16% to about 21% by weight of HFO-1132(E);
(2) from about 32% to about 52% by weight of HFC-161; and
(3) from about 40% to about 50% by weight of R-290.
   The refrigerant according to this paragraph is sometimes referred to herein for convenience as Refrigerant 1B.

The present invention includes refrigerants consisting of:
(1) from about 12% to about 35% by weight of HFO-1132(E);
(2) from about 20% to about 41% by weight of HFC-161; and
(3) from about 42% to about 60% by weight of R-290.
   The refrigerant according to this paragraph is sometimes referred to herein for convenience as Refrigerant 1C.

The present invention includes refrigerants comprising:
(1) about 34% by weight of HFO-1132(E);
(2) about 37% by weight of HFC-161; and
(3) about 29% by weight of R-290,
   wherein said refrigerant has a Global Warming Potential (GWP) of 10 or less.
      The refrigerant according to this paragraph is sometimes referred to herein for convenience as Refrigerant 2A.

The present invention includes refrigerants consisting essentially of:
(1) about 34% by weight of HFO-1132(E);
(2) about 37% by weight of HFC-161; and
(3) about 29% by weight of R-290.
   The refrigerant according to this paragraph is sometimes referred to herein for convenience as Refrigerant 2B.

The present invention includes refrigerants consisting of:
(1) about 34% by weight of HFO-1132(E);
(2) about 37% by weight of HFC-161; and
(3) about 29% by weight of R-290.
   The refrigerant according to this paragraph is sometimes referred to herein for convenience as Refrigerant 2C.

The present invention includes refrigerants comprising:
(1) from about 16% to about 21% by weight of HFO-1132(E);
(2) from about 32% to about 52% by weight of HFC-161; and
(3) from about 40% to about 50% by weight of R-290,
   wherein said refrigerant has:
      (a) a Global Warming Potential (GWP) of 50 or less; and
      (b) a glide at about 0° C. of less than about 2° C.
         The refrigerant according to this paragraph is sometimes referred to herein for convenience as Refrigerant 3A.

The present invention includes refrigerants consisting essentially of:
(1) from about 16% to about 21% by weight of HFO-1132(E);
(2) from about 32% to about 52% by weight of HFC-161; and
(3) from about 40% to about 50% by weight of R-290.
   The refrigerant according to this paragraph is sometimes referred to herein for convenience as Refrigerant 3B.

The present invention includes refrigerants consisting of:
(1) from about 16% to about 21% by weight of HFO-1132(E);
(2) from about 32% to about 52% by weight of HFC-161; and
(3) from about 40% to about 50% by weight of R-290.
   The refrigerant according to this paragraph is sometimes referred to herein for convenience as Refrigerant 3C.

The present invention includes refrigerants consisting essentially of the following three components in the following relative concentrations:
(1) about 15% to about 20% by weight of HFO-1132(E);
(2) about 32.5% to about by 52.5% weight of HFC-161; and
(3) about 27% to about 45% by weight of R-290.
   The refrigerant according to this paragraph is sometimes referred to herein for convenience as Refrigerant 4.

The present invention includes refrigerants consisting essentially of the following three components in the following relative concentrations:
(1) about 17.1% by weight of HFO-1132(E);
(2) about 39.9% by weight of HFC-161; and
(3) about 43% by weight of R-290.
   The refrigerant according to this paragraph is sometimes referred to herein for convenience as Refrigerant 5A.

The present invention includes refrigerants consisting essentially of the following three components in the following relative concentrations:
(1) about 18.3% by weight of HFO-1132(E);
(2) about 33.4% by weight of HFC-161; and
(3) about 48.3% by weight of R-290.
   The refrigerant according to this paragraph is sometimes referred to herein for convenience as Refrigerant 5B.

The present invention includes refrigerants consisting essentially of the following three components in the following relative concentrations:
(1) about 20% by weight of HFO-1132(E);
(2) about 51.6% by weight of HFC-161; and
(3) about 28.4% by weight of R-290.
   The refrigerant according to this paragraph is sometimes referred to herein for convenience as Refrigerant 5C.

The present invention includes refrigerants consisting essentially of the following three components in the following relative concentrations:
(1) about 33.7% by weight of HFO-1132(E);
(2) about 36.7% by weight of HFC-161; and
(3) about 29.6% by weight of R-290.
   The refrigerant according to this paragraph is sometimes referred to herein for convenience as Refrigerant 5D.

The present invention includes methods of providing heating to a heat sink comprising a fluid or body to be heated comprising:
(1) providing a vapor compression refrigeration system comprising a compressor for compressing a refrigerant in a vapor phase, a condenser transferring heat from said vapor phase refrigerant to the heat and an evaporator transferring heat from a heat source to said refrigerant in the liquid phase, wherein said refrigerant comprises one or more of Refrigerants 1-5; and
(2) evaporating said refrigerant in said evaporator, wherein said refrigerant has a volumetric capacity in said system that is at least about 120% of the volumetric capacity of R-290 in said system.
   The method according to this paragraph is sometimes referred to herein for convenience as Heat Transfer Method 1A.

The present invention includes methods of providing heating to a heat sink comprising a fluid or body to be heated comprising:
(1) providing a vapor compression refrigeration system comprising a compressor for compressing a refrigerant in a vapor phase, a condenser transferring heat from said vapor phase refrigerant to the heat sink, and an evaporator transferring heat from a heat source to said refrigerant in the liquid phase, wherein said refrigerant comprises one or more of Refrigerants 1-5, wherein said refrigerant has a COP in said system that is at least 97% of the COP of R-290 in said system.
   The method according to this paragraph is sometimes referred to herein for convenience as Heat Transfer Method 1B.

The present invention includes methods of providing heating to a heat sink comprising a fluid or body to be heated comprising:
(1) providing a vapor compression refrigeration system comprising a compressor for compressing a refrigerant in a vapor phase, a condenser transferring heat from said vapor phase refrigerant to the heat sink at a temperature of from about 70° C. to about 130° C., and a direct expansion evaporator transferring heat from a heat source at a temperature of from about 30° C. to about 90° C. to said refrigerant in the liquid phase, wherein said refrigerant comprises one or more of Refrigerants 1-5; and
(2) evaporating said refrigerant in said evaporator, wherein said refrigerant has a volumetric capacity in said system that is at least about 120% of the volumetric capacity of R-290 in said system and (3) has a COP in said system that is at least 96% of the COP of R-290 in said system.
   The method according to this paragraph is sometimes referred to herein for convenience as Heat Transfer Method 1C.

The present invention includes vapor compression heat transfer systems comprising a fluid or body to absorb heat or to be heated comprising:
(1) a refrigerant;
(2) a compressor for compressing said refrigerant in a vapor phase;
(3) a condenser transferring heat using said refrigerant vapor; and
(4) an evaporator transferring heat using said refrigerant liquid,
(5) wherein said refrigerant comprises one or more of Refrigerants 1-5.
   The heat transfer system according to this paragraph is sometimes referred to herein for convenience as Heat Transfer System 1.

The present invention includes vapor compression heat pumps providing heat to a heat sink comprising a fluid or body to be heated comprising:
(1) a refrigerant;
(2) a compressor for compressing said refrigerant in a vapor phase;
(3) a condenser transferring heat from said vapor phase; and
(4) an evaporator transferring heat from a heat source to said refrigerant in the liquid phase,
(5) wherein said refrigerant comprises one or more of Refrigerants 1-5.

The heat pump according to this paragraph is sometimes referred to herein for convenience as Heat Pump 1.

### BRIEF DESCRIPTION OF THE FIGURES

FIG. 1 is a schematic representation of an exemplary heat transfer system that can use the present refrigerants in either a heating mode (as a heat pump) or in a cooling mode (as an air conditioner, low temperature refrigeration circuit, medium temperature refrigeration circuit, etc.) in accordance with the present systems and methods.

FIG. 2A is a schematic representation of a typical residential heat pump system, operating in the cooling mode.

FIG. 2B is a schematic representation of a typical residential heat pump system, operating in the heating mode.

### DETAILED DESCRIPTION

### Definitions

The phrase “coefficient of performance” (herein abbreviated as “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration, cooling or heating capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988 which is incorporated herein by reference in its entirety).

The phrase “Global Warming Potential” (herein abbreviated as “GWP”) was developed to allow comparisons of the global warming impact of different gases. It compares the amount of heat trapped by a certain mass of a gas to the amount of heat trapped by a similar mass of carbon dioxide over a specific time period of time. Carbon dioxide was chosen by the Intergovernmental Panel on Climate Change (IPCC) as the reference gas and its GWP is taken as 1. The larger GWP, the more that a given gas warms the Earth compared to CO2 over that time period. As used herein, the term GWP means the value of GWP as measured in accordance with IPCC Fourth Assessment Report, 20141, referred to and abbreviated herein as AR4, except for components that did not have a GWP value measured in AR4 (such as R1233zd(E) and R1234ze(E)), then the values used are according to the Fifth Assessment Report.

The phrase “acceptable toxicity” as used herein means the composition is classified as class “A” by ASHRAE Standard 34-2016 Designation and Safety Classification of Refrigerants and described in Appendix B1 to ASHRAE Standard 34-2016 (as each standard exists as of the filing date of this application). A substance which is flammable and has acceptable-toxicity, would be classified as “A3” by ASHRAE Standard 34-2016 Designation and Safety Classification of Refrigerants and described in Appendix B1 to ASHRAE Standard 34-2016 (as each standard exists as of the filing date of this application).

As the term is used herein, “replacement for” with respect to a particular heat transfer composition or refrigerant of the present invention as a “replacement for” a particular prior refrigerant means the use of the indicated composition of the present invention in a heat transfer system that heretofore had been commonly used with that prior refrigerant. By way of example, when a refrigerant or heat transfer composition of the present invention is used in a heat transfer ¹Myhre, G., D. Shindell, F.-M. Bréon, W. Collins, J. Fuglestvedt, J. Huang, D. Koch, J.-F. Lamarque, D. Lee, B. Mendoza, T. Nakajima, A. Robock, G.Stephens, T. Takemura and H. Zhang, 2013: Anthropogenic and Natural Radiative Forcing. In: Climate Change 2013: The Physical Science Basis.Contribution of Working Group I to the Fifth Assessment Report of the Intergovernmental Panel on Climate Change [Stocker, T. F., D. Qin, G.-K.Plattner, M. Tignor, S. K. Allen, J. Boschung, A. Nauels, Y. Xia, V. Bex and P. M. Midgley (eds.)]. Cambridge University Press, Cambridge, United Kingdom and New York, NY, USA.https://www.ipcc.ch/pdf/assessmentreport/ar5/wg1/WG1AR5_Chapter08_FINAL.pdf (p. 73-79) system that has heretofore been designed for and/or commonly used with R410A, such as residential air conditioning and commercial air conditioning (including roof top systems, variable refrigerant flow (VRF) systems and chiller systems) then the present refrigerant is a replacement for R410A is such systems.

The term “degree of superheat” or simply “superheat” means the temperature rise of the refrigerant at the exit of the evaporator above the saturated vapor temperature (or dew temperature) of the refrigerant.

As used herein, the term “evaporator glide” means the difference between the saturation temperature of the refrigerant at the entrance to the evaporator and the dew point of the refrigerant at the exit of the evaporator, assuming the pressure at the evaporator exit is the same as the pressure at the inlet. As used herein, the phrase ‘saturation temperature” means the temperature at which the liquid refrigerant boils into vapor at a given pressure.

As used herein, the term “condenser glide” means the difference between the dew point temperature of the refrigerant at or near the entrance to the condenser and the saturation temperature of the refrigerant at or near the exit of the condenser, assuming the pressure at the condenser exit is the same as the pressure at the inlet. As used herein, the phrase ‘saturation temperature” means the temperature at which the liquid refrigerant boils into vapor at a given pressure.

As used herein, the terms “direct expansion evaporator” and “Dx Evaporator” means a heat exchanger which receives a zeotropic liquid refrigerant blend and produces an unfractionated, superheated vapor of said zeotropic refrigerant blend.

As used herein, the term “flooded evaporator” means a heat exchanger which transfers heat to a boiling reservoir of liquid refrigerant.

The terms “R-1132(E)”, “HFO-1132 (E)” and “transHFO-1132 (E)” each means the trans isomer of 1,2-difluorethylene.

The terms “R-161” and “HFC-161” as used herein each means fluoroethane.

As used herein the terms “heat pump system” and “heat pump” means a vapor compression system operable in a heating mode.

As used herein, reference to a defined group, such as “Refrigerant 1-5,” refers to each composition within that group, including wherein a definition number includes a suffix. For example, reference to Refrigerant 1-2 includes reference to each of Refrigerant 1A, Refrigerant 1B, Refrigerant 1C, Refrigerant 2A, Refrigerant 2B and Refrigerant 2C, etc.

As used herein, the term “about” in relation to the amount expressed in weight percent means that the amount of the component can vary by an amount of +/−10% on a relative basis by weight. Thus, if an amount is described as being “about 10 wt. %,” then it is intended to cover amounts of 10 wt. %+/−1 wt. %, and if an amount is described as being “about 20 wt. %,” then it is intended to cover amounts of 20 wt. %+/−2 wt. %, etc.

### Heat Pumps

A heat pump (sometimes referred to herein for convenience as “HP”) in its basic configuration comprises a fluid circuit which utilizes a circulating refrigerant to take-up or absorb heat from at least a first reservoir of heat (sometimes referred to herein as a “heat source”) at a relatively low temperature (sometimes referred to herein for convenience as a “low temperature heat source”) and then emitting or transmitting heat to at least a second reservoir which absorbs the heat (sometimes referred to herein as a heat sink) at a relatively high temperature (sometimes referred to herein for convenience as a “high temperature heat sink”). In preferred configurations the low temperature heat source is a plentiful source of heat at a relatively low temperature, such as might be available from low temperature industrial waste heat, geothermal energy from the ground and/or ground water, and the like, and the high temperature heat sink is a fluid which is desired to maintain in a relatively higher temperature range, such as hot water or steam or hot air.

The temperature of the low temperature heat source to be used in connection with the present refrigerants, systems and methods can vary widely. Examples of low temperature heat sources useful in connection with the present invention include low grade industrial heat, air from the environment, water from the environment, brine, and in the case of geothermal energy, from the earth, including ground water.

With respect to the high temperature heat sinks which can absorb heat, the present invention is believed to be useful for a wide range of such heat sinks, including hot air, hot water (e.g., hot water at a temperature of at least about 55° C.), and steam.

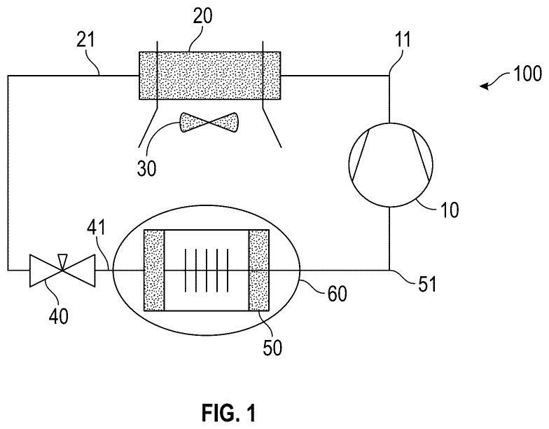

FIG. 1 is a generalized schematic view of a heat transfer system that can be used as basic heat pump device which contains and operates with the refrigerants of the present invention, including each of Refrigerants 1 to 5.

FIG. 1 illustrates in block diagram form a heat transfer system 100, which may be for example a heat pump, according to the present invention. The system includes an a HP mode an evaporator 50 that receives heat from the low temperature heat source (represented schematically by the oval 60), including by undergoing a phase change from liquid to vapor as heat is absorbed from the low temperature heat source. It will be appreciated, however, that some level of sensible heat may also transferred to the refrigerants of the present invention, including each of Refrigerants 1-5, by the low temperature heat source. The vaporous refrigerant which exits evaporator 50 via line 51 is introduced to the suction side of compressor 10 which adds work to the refrigerant and increases both the temperature and the pressure of the refrigerant vapor. This high temperature vapor from the compressor 10 is transported via line 11 to the condenser 20 in which the refrigerant of the present invention, including each of Refrigerants 1-5, supplies heat at a relatively high temperature to the high temperature heat sink, which is represented schematically (but not by way of limitation) by fan 30. The condensed refrigerant of the present invention is then transported by line 21 to a pressure reducing device 40, such as an expansion valve, a throttle valve, capillary tube, orifice valve and the like, where the pressure of the liquid refrigerant is reduced, thus producing relatively low temperature liquid refrigerant, which is then introduced via line 41 to the evaporator 50, where the cycle begins again. This description does not limit any possible additional variances for the specific equipment or the use of additional components that are not illustrated in FIG. 1, such as suction line heat exchangers, vapor ejectors, those mentioned in the background above and the like.

The specific type of equipment used in the present heat pump systems can vary widely within the scope of the present invention. For example, the compressor can be of centrifugal, screw and positive displacement type.

With respect to the heat exchangers 50 and 20, applicants note that the preferred refrigerants of the present invention have condenser glides and evaporator glides of from about 2° C. or less for the use of the refrigerants of the present invention, including each of Refrigerants 1-5.

The type of expansion device used can vary. The expansion device can be an expansion valve, which can be electronic or thermostatic as needed by the specifics of the design.

Applicants have found that the refrigerant compositions of the present invention, including each of Refrigerants 1-5, are able to satisfy in an exceptional and unexpected way the need for heat transfer systems in general, and HP systems in particular, having excellent performance with respect to environmental impact while at the same time providing other important performance characteristics, such as, but not limited to, high capacity and efficiency, acceptable toxicity and low glide.

In preferred embodiments the present compositions provide alternatives and/or replacements for working fluids currently used in heat transfer systems, and particularly in high temperature heat pump applications, particularly and preferably as alternatives and/or replacements for R-290.

### Heat Transfer Compositions

The compositions of the present invention are those which include refrigerants of the present invention, including each of Refrigerants 1-5. Applicants have found that use in the present refrigerants, including each of Refrigerants 1-5, of the components of the present invention within the stated ranges is important to achieve the important but difficult to achieve combinations of properties exhibited by the present compositions, particularly in the preferred HP systems and methods, in the refrigeration systems and methos, and in the air conditioning systems and methods.

The heat transfer compositions of the present invention may include, in addition to the present refrigerants, other components for the purpose of enhancing or providing certain functionality to the heat transfer composition, and/or in some cases to reduce the cost of the composition. For example, heat transfer compositions which include the present refrigerants, including Refrigerants 1-5, can also include one or more lubricants. The amount of the lubricant in the heat transfer composition can vary, generally in amounts of from as little as 0.1 percent by weight to up to about 20 percent by weight. For a given system, the relative amount of the lubricant present in the system as a percentage of the total amount of lubricant and refrigerant in system can also vary widely, such as from about 30 to about 50 percent by weight.

Applicants have found that Polyol Esters (POEs) and Poly Vinyl Ethers (PVEs), PAG oils, silicone oil, lubricants that have been used in refrigeration machinery with previously used hydrofluorocarbon (HFC) refrigerants may, in certain embodiments, be used to advantage in the heat transfer compositions and in the high temperature heat pump (“HTHP”) systems and methods of the present invention. Commercially available esters include neopentyl glycol dipelargonate, which is available as Emery 2917 (registered trademark) and Hatcol 2370 (registered trademark). Other useful esters include phosphate esters, dibasic acid esters, and fluoroesters. Preferred lubricants include POEs and PVEs. Of course, different mixtures of different types of lubricants may be used.

The heat transfer compositions (HTCs) according to the present invention comprise a refrigerant of the present invention (identified by Refrigerant Number) and lubricant as identified and defined in the following Heat Transfer Composition Table (Table 1).

TABLE 1

| | Refrigerant | Refrigerant | Lubricant | Lubricant |
|---|---|---|---|---|
| HTC No. | No. | amount, wt % | Type* | Amount. Wt % |
| HTC1A1 | 1A | 90-99.9 | NR | NR |
| HTC1B1 | 1A | 90-99.9 | NR | 0.1-10 |
| HTC1C1 | 1A | 90-99.9 | POE | NR |
| HTC1D1 | 1A | 90-99.9 | POE | 0.1-10 |
| HTC1E1 | 1A | 90-99.9 | PVE | NR |
| HTC1F1 | 1A | 90-99.9 | PVE | 0.1-10 |
| HTC1A2 | 1B | 90-99.9 | NR | NR |
| HTC1B2 | 1B | 90-99.9 | NR | 0.1-10 |
| HTC1C2 | 1B | 90-99.9 | POE | NR |
| HTC1D2 | 1B | 90-99.9 | POE | 0.1-10 |
| HTC1E2 | 1B | 90-99.9 | PVE | NR |
| HTC1F2 | 1B | 90-99.9 | PVE | 0.1-10 |
| HTC1A3 | 1C | 90-99.9 | NR | NR |
| HTC1B3 | 1C | 90-99.9 | NR | 0.1-10 |
| HTC1C3 | 1C | 90-99.9 | POE | NR |
| HTC1D3 | 1C | 90-99.9 | POE | 0.1-10 |
| HTC1E3 | 1C | 90-99.9 | PVE | NR |
| HTC1F3 | 1C | 90-99.9 | PVE | 0.1-10 |
| HTC2A1 | 2A | 90-99.9 | NR | NR |
| HTC2B1 | 2A | 90-99.9 | NR | 0.1-10 |
| HTC2C1 | 2A | 90-99.9 | POE | NR |
| HTC2D1 | 2A | 90-99.9 | POE | 0.1-10 |
| HTC2E1 | 2A | 90-99.9 | PVE | NR |
| HTC2F1 | 2A | 90-99.9 | PVE | 0.1-10 |
| HTC2A2 | 2B | 90-99.9 | NR | NR |
| HTC2B2 | 2B | 90-99.9 | NR | 0.1-10 |
| HTC2C2 | 2B | 90-99.9 | POE | NR |
| HTC2D2 | 2B | 90-99.9 | POE | 0.1-10 |
| HTC2E2 | 2B | 90-99.9 | PVE | NR |
| HTC2F2 | 2B | 90-99.9 | PVE | 0.1-10 |
| HTC2A3 | 2C | 90-99.9 | NR | NR |
| HTC2B3 | 2C | 90-99.9 | NR | 0.1-10 |
| HTC2C3 | 2C | 90-99.9 | POE | NR |
| HTC2D3 | 2C | 90-99.9 | POE | 0.1-10 |
| HTC2E3 | 2C | 90-99.9 | PVE | NR |
| HTC2F3 | 2C | 90-99.9 | PVE | 0.1-10 |
| HTC3A1 | 3A | 90-99.9 | NR | NR |
| HTC3B1 | 3A | 90-99.9 | NR | 0.1-10 |
| HTC3C1 | 3A | 90-99.9 | POE | NR |
| HTC3D1 | 3A | 90-99.9 | POE | 0.1-10 |
| HTC3E1 | 3A | 90-99.9 | PVE | NR |
| HTC3F1 | 3A | 90-99.9 | PVE | 0.1-10 |
| HTC3A2 | 3B | 90-99.9 | NR | NR |
| HTC3B2 | 3B | 90-99.9 | NR | 0.1-10 |
| HTC3C2 | 3B | 90-99.9 | POE | NR |
| HTC3D2 | 3B | 90-99.9 | POE | 0.1-10 |
| HTC3E2 | 3B | 90-99.9 | PVE | NR |
| HTC3F2 | 3B | 90-99.9 | PVE | 0.1-10 |
| HTC3A3 | 3C | 90-99.9 | NR | NR |
| HTC3B3 | 3C | 90-99.9 | NR | 0.1-10 |
| HTC3C3 | 3C | 90-99.9 | POE | NR |
| HTC3D3 | 30 | 90-99.9 | POE | 0.1-10 |
| HTC3E3 | 3C | 90-99.9 | PVE | NR |
| HTC3F3 | 3C | 90-99.9 | PVE | 0.1-10 |
| HTC4A1 | 4 | 90-99.9 | NR | NR |
| HTC4B1 | 4 | 90-99.9 | NR | 0.1-10 |
| HTC4C1 | 4 | 90-99.9 | POE | NR |
| HTC4D1 | 4 | 90-99.9 | POE | 0.1-10 |
| HTC4E1 | 4 | 90-99.9 | PVE | NR |
| HTC4F1 | 4 | 90-99.9 | PVE | 0.1-10 |
| HTC5A1 | 5A | 90-99.9 | NR | NR |
| HTC5B1 | 5A | 90-99.9 | NR | 0.1-10 |
| HTC5C1 | 5A | 90-99.9 | POE | NR |
| HTC5D1 | 5A | 90-99.9 | POE | 0.1-10 |
| HTC5E1 | 5A | 90-99.9 | PVE | NR |
| HTC5F1 | 5A | 90-99.9 | PVE | 0.1-10 |
| HTC5A2 | 5B | 90-99.9 | NR | NR |
| HTC5B2 | 5B | 90-99.9 | NR | 0.1-10 |
| HTC5C2 | 5B | 90-99.9 | POE | NR |
| HTC5D2 | 5B | 90-99.9 | POE | 0.1-10 |
| HTC5E2 | 5B | 90-99.9 | PVE | NR |
| HTC5F2 | 5B | 90-99.9 | PVE | 0.1-10 |
| HTC5A3 | 5C | 90-99.9 | NR | NR |
| HTC5B3 | 5C | 90-99.9 | NR | 0.1-10 |
| HTC5C3 | 5C | 90-99.9 | POE | NR |
| HTC5D3 | 5C | 90-99.9 | POE | 0.1-10 |
| HTC5E3 | 5C | 90-99.9 | PVE | NR |
| HTC5F3 | 5D | 90-99.9 | PVE | 0.1-10 |
| HTC5A4 | 5D | 90-99.9 | NR | NR |
| HTC5B4 | 5D | 90-99.9 | NR | 0.1-10 |
| HTC5C4 | 5D | 90-99.9 | POE | NR |
| HTC5D4 | 5D | 90-99.9 | POE | 0.1-10 |
| HTC5E4 | 5D | 90-99.9 | PVE | NR |
| HTC5F4 | 5D | 90-99.9 | PVE | 0.1-10 |

*The following designations have the following meanings in the table: NR means that the type or amount is not required, i.e, that all types and amounts are within the definition.

### Heat Transfer Methods and Systems

The present methods, systems and compositions are thus adaptable for use in connection with a wide variety of heat transfer systems in general and for HP, refrigeration systems and air conditioning systems in particular. The compressor used in the system can vary widely, including centrifugal type and screw type, but other types like scroll may also be used. The heat exchangers can also vary widely, including but not limited to direct expansion shell-tube type (with the refrigerant preferably on the tube-side) and brazed plate heat exchanger. The heat transfer systems of the present invention may also include in preferred embodiments an economizer with vapor injection and suction line heat exchangers.

As mentioned above, the present invention achieves exceptional advantages in connection with heat transfer systems. Non-limiting examples of such systems are provided in the Examples below. The examples below provide typical conditions and parameters for certain applications but do not limit the broad scope of the operation of the systems and methods of the present invention. To this end, the conditions used in the examples are generally representative of but are not considered to be necessary limiting of the invention, as one of skill in the art will appreciate that they may be varied based on one or more of a myriad of factors, including but not limited to, ambient conditions, intended application, time of year, and the like.

It is contemplated that in certain embodiments the present invention provides methods of reducing the cost of providing a high temperature heat pump by replacing at least a substantial portion of the heat transfer fluid (including the refrigerant and optionally the lubricant) in an existing system with a refrigerant of the present invention, including each of Refrigerants 1-5. One advantage of the present replacement methods is the ability to achieve either a reduced cost for the system, as a result of the ability to use in the same application a compressor having a substantially reduced displacement compared to previously used refrigerants, including propane, or to achieve an increased capacity compared to R-290 using the same compressor.

The present invention also includes and provides a particular advantage in connection with replacement of propane (R-290) in any of the following systems: residential and commercial heat pumps; residential and commercial refrigeration; residential and commercial air conditioning; and high temperature heat pumps.

The following Table 2 provides particularly preferred combinations of the present refrigerants as replacements for prior refrigerants in particular systems.

TABLE 2

| | Refrigerant | |
|---|---|---|
| | Being | |
| Refrigerant No. | Replaced | System Type |
| Refrigerant 1A | R-290 | Residential Heat Pump |
| Refrigerant 1B | R-290 | Residential Heat Pump |
| Refrigerant 1C | R-290 | Residential Heat Pump |
| Refrigerant 2A | R-290 | Residential Heat Pump |
| Refrigerant 2B | R-290 | Residential Heat Pump |
| Refrigerant 2C | R-290 | Residential Heat Pump |
| Refrigerant 3A | R-290 | Residential Heat Pump |
| Refrigerant 3B | R-290 | Residential Heat Pump |
| Refrigerant 3C | R-290 | Residential Heat Pump |
| Refrigerant 4 | R-290 | Residential Heat Pump |
| Refrigerant 5A | R-290 | Residential Heat Pump |
| Refrigerant 5B | R-290 | Residential Heat Pump |
| Refrigerant 5C | R-290 | Residential Heat Pump |
| Refrigerant 5D | R-290 | Residential Heat Pump |
| Refrigerant 1A | R-290 | Commercial Heat Pump |
| Refrigerant 1B | R-290 | Commercial Heat Pump |
| Refrigerant 1C | R-290 | Commercial Heat Pump |
| Refrigerant 2A | R-290 | Commercial Heat Pump |
| Refrigerant 2B | R-290 | Commercial Heat Pump |
| Refrigerant 2C | R-290 | Commercial Heat Pump |
| Refrigerant 3A | R-290 | Commercial Heat Pump |
| Refrigerant 3B | R-290 | Commercial Heat Pump |
| Refrigerant 3C | R-290 | Commercial Heat Pump |
| Refrigerant 4 | R-290 | Commercial Heat Pump |
| Refrigerant 5A | R-290 | Commercial Heat Pump |
| Refrigerant 5B | R-290 | Commercial Heat Pump |
| Refrigerant 5C | R-290 | Commercial Heat Pump |
| Refrigerant 5D | R-290 | Commercial Heat Pump |
| Refrigerant 1A | R-290 | Residential Air |
| | | Conditioning |
| Refrigerant 1B | R-290 | Residential Air |
| | | Conditioning |
| Refrigerant 1C | R-290 | Residential Air |
| | | Conditioning |
| Refrigerant 2A | R-290 | Residential Air |
| | | Conditioning |
| Refrigerant 2B | R-290 | Residential Air |
| | | Conditioning |
| Refrigerant 2C | R-290 | Residential Air |
| | | Conditioning |
| Refrigerant 3A | R-290 | Residential Air |
| | | Conditioning |
| Refrigerant 3B | R-290 | Residential Air |
| | | Conditioning |
| Refrigerant 3C | R-290 | Residential Air |
| | | Conditioning |
| Refrigerant 4 | R-290 | Residential Air |
| | | Conditioning |
| Refrigerant 5A | R-290 | Residential Air |
| | | Conditioning |
| Refrigerant 5B | R-290 | Residential Air |
| | | Conditioning |
| Refrigerant 5C | R-290 | Residential Air |
| | | Conditioning |
| Refrigerant 5D | R-290 | Residential Air |
| | | Conditioning |
| Refrigerant 1A | R-290 | Commercial Air |
| | | Conditioning |
| Refrigerant 1B | R-290 | Commercial Air |
| | | Conditioning |
| Refrigerant 1C | R-290 | Commercial Air |
| | | Conditioning |
| Refrigerant 2A | R-290 | Commercial Air |
| | | Conditioning |
| Refrigerant 2B | R-290 | Commercial Air |
| | | Conditioning |
| Refrigerant 2C | R-290 | Commercial Air |
| | | Conditioning |
| Refrigerant 3A | R-290 | Commercial Air |
| | | Conditioning |
| Refrigerant 3B | R-290 | Commercial Air |
| | | Conditioning |
| Refrigerant 3C | R-290 | Commercial Air |
| | | Conditioning |
| Refrigerant 4 | R-290 | Commercial Air |
| | | Conditioning |
| Refrigerant 5A | R-290 | Commercial Air |
| | | Conditioning |
| Refrigerant 5B | R-290 | Commercial Air |
| | | Conditioning |
| Refrigerant 5C | R-290 | Commercial Air |
| | | Conditioning |
| Refrigerant 5D | R-290 | Commercial Air |
| | | Conditioning |
| Refrigerant 1A | R-290 | Residential |
| | | Refrigeration |
| Refrigerant 1B | R-290 | Residential |
| | | Refrigeration |
| Refrigerant 1C | R-290 | Residential |
| | | Refrigeration |
| Refrigerant 2A | R-290 | Residential |
| | | Refrigeration |
| Refrigerant 2B | R-290 | Residential |
| | | Refrigeration |
| Refrigerant 2C | R-290 | Residential |
| | | Refrigeration |
| Refrigerant 3A | R-290 | Residential |
| | | Refrigeration |
| Refrigerant 3B | R-290 | Residential |
| | | Refrigeration |
| Refrigerant 3C | R-290 | Residential |
| | | Refrigeration |
| Refrigerant 4 | R-290 | Residential |
| | | Refrigeration |
| Refrigerant 5A | R-290 | Residential |
| | | Refrigeration |
| Refrigerant 5B | R-290 | Residential |
| | | Refrigeration |
| Refrigerant 5C | R-290 | Residential |
| | | Refrigeration |
| Refrigerant 5D | R-290 | Residential |
| | | Refrigeration |
| Refrigerant 1A | R-290 | Commercial |
| | | Refrigeration |
| Refrigerant 1B | R-290 | Commercial |
| | | Refrigeration |
| Refrigerant 1C | R-290 | Commercial |
| | | Refrigeration |
| Refrigerant 2A | R-290 | Commercial |
| | | Refrigeration |
| Refrigerant 2B | R-290 | Commercial |
| | | Refrigeration |
| Refrigerant 2C | R-290 | Commercial |
| | | Refrigeration |
| Refrigerant 3A | R-290 | Commercial |
| | | Refrigeration |
| Refrigerant 3B | R-290 | Commercial |
| | | Refrigeration |
| Refrigerant 3C | R-290 | Commercial |
| | | Refrigeration |
| Refrigerant 4 | R-290 | Commercial |
| | | Refrigeration |
| Refrigerant 5A | R-290 | Commercial |
| | | Refrigeration |
| Refrigerant 5B | R-290 | Commercial |
| | | Refrigeration |
| Refrigerant 5C | R-290 | Commercial |
| | | Refrigeration |
| Refrigerant 5D | R-290 | Commercial |
| | | Refrigeration |
| Refrigerant 1A | R-290 | High Temperature Heat |
| | | Pump |
| Refrigerant 1B | R-290 | High Temperature Heat |
| | | Pump |
| Refrigerant 1C | R-290 | High Temperature Heat |
| | | Pump |
| Refrigerant 2A | R-290 | High Temperature Heat |
| | | Pump |
| Refrigerant 2B | R-290 | High Temperature Heat |
| | | Pump |
| Refrigerant 2C | R-290 | High Temperature Heat |
| | | Pump |
| Refrigerant 3A | R-290 | High Temperature Heat |
| | | Pump |
| Refrigerant 3B | R-290 | High Temperature Heat |
| | | Pump |
| Refrigerant 3C | R-290 | High Temperature Heat |
| | | Pump |
| Refrigerant 4 | R-290 | High Temperature Heat |
| | | Pump |
| Refrigerant 5A | R-290 | High Temperature Heat |
| | | Pump |
| Refrigerant 5B | R-290 | High Temperature Heat |
| | | Pump |
| Refrigerant 5C | R-290 | High Temperature Heat |
| | | Pump |
| Refrigerant 5D | R-290 | High Temperature Heat |
| | | Pump |

The present disclosure includes methods for providing heating comprising:
(a) evaporating a refrigerant according to the present disclosure, including each of Refrigerants 1-5, in the vicinity of the heat source (external air, ground or water) to be cooled at a temperature of from about −40° C. to about +15° C. to produce a refrigerant vapor;
(b) compressing said refrigerant vapor to produce a refrigerant at discharge temperature of less than about 135° C.; and
(c) condensing the refrigerant from said compressor at a temperature of from about 20° C. to about 70° C. in the vicinity of the heat sink (water or another secondary fluid) to produce a refrigerant liquid. The heated water or secondary fluid is then pumped throughout the building to provide heating. Heating methods in accordance with this paragraph are referred to herein as Heating Method 1.

The present disclosure includes methods for providing heating comprising:
(a) evaporating a refrigerant according to the present disclosure, including each of Refrigerants 1-5, in the vicinity of the heat source (external air, ground or water) to be cooled at a temperature of from about −40° C. to about +15° C. to produce a refrigerant vapor;
(b) compressing said refrigerant vapor to produce a refrigerant at discharge temperature of less than about 135° C.; and
(c) condensing the refrigerant from said compressor at a temperature of from about 20° C. to about 70° C. in the vicinity of the heat sink (indoor air) to produce a refrigerant liquid and provide heating. Heating methods in accordance with this paragraph are referred to herein as Heating Method 2.

The present disclosure includes conducting heating according to Heating Method 1 in any one of the following systems: air-to-water heat pump systems, ground-source heat pump systems, water-source heat pump systems.

The present disclosure includes conducting heating according to Heating Method 2 in any one of the following systems: air-to-air heat pump systems, ground-source heat pump systems and water-source heat pump systems.

The present disclosure includes methods for replacing the refrigerant in an R-290 heat pump system comprising:
(a) using instead of the R-290 in said heat pump system a refrigerant according to the present disclosure, including each of Refrigerants 1-5, wherein said refrigerant operating in said system has a capacity of at least about 120% of the use of R-290 in said system. Methods in accordance with this paragraph are referred to herein as Replacement Method 1A.

The present disclosure includes methods for replacing the refrigerant in an R-290 heat pump system comprising:
(a) using instead of the R-290 in said heat pump system a refrigerant according to the present disclosure, including each of Refrigerants 1-5, wherein said refrigerant operating in said system has a capacity of at least about 130% of the capacity of R290 in said system. Methods in accordance with this paragraph are referred to herein as Replacement Method 1B.

The present disclosure includes methods for replacing the refrigerant in an R-290 heat pump system comprising:
(a) using instead of the R-290 in said heat pump system a refrigerant according to the present disclosure, including each of Refrigerants 1-5, wherein said refrigerant operating in said system has a capacity of at least about 140% of the capacity of R290 in said system. Methods in accordance with this paragraph are referred to herein as Replacement Method 1C.

The present disclosure includes methods for replacing the refrigerant in an R-290 heat pump system comprising:
(a) using instead of the R-290 in said heat pump system a refrigerant according to the present disclosure, including each of Refrigerants 1-5, wherein said refrigerant operating in said system has a capacity of at least about 140% of the capacity of R290 in said system. Methods in accordance with this paragraph are referred to herein as Replacement Method 1D.

### EXAMPLES

The following examples are provided for the purpose of illustrating the present invention but without limiting the scope thereof. The exemplary refrigerant compositions used in the examples are described in Table A below as Refrigerants ExA-ExD:

| Compo- | R-1132(E) mass | R-290 mass | R-161 mass | |
|---|---|---|---|---|
| sition | concentration | concentration | concentration | GWP |
| ExA | 17.1% | 43.0% | 39.9% | 17.1% |
| ExB | 18.3% | 48.3% | 33.4% | 18.3% |
| ExC | 20.0% | 28.4% | 51.6% | 20.0% |
| ExD | 33.7% | 29.6% | 36.7% | 33.7% |

### Example 1—Cold Climate Air to Air Heat Pumps-Mini-Split Systems

This example illustrates cold climate air to air heat pump systems, such as mini-split systems, rooftop systems, central heat pump systems, and any heat pump system that uses the external air as a heat source for its evaporator and heats the indoor air flow through its condenser.

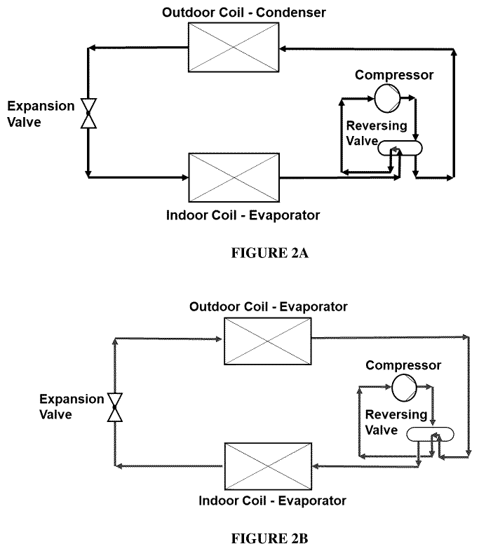

An exemplary residential heat pump/air conditioning system known as a ductless mini-split system is used corresponding generally to the basic structure shown in FIG. 2B is operated in the heating mode (as shown in FIG. 2B). The system comprises a compressor, an outdoor condenser, an expansion valve, an indoor evaporator, and the reversing valve. As is typical in operation of systems of this type in the heating mode, the reversing valve is set to direct high temperature vapor from the compressor to the inlet of the indoor condenser, wherein hot vapor heats the indoor ambient air as it condenses in refrigerant liquid. Liquid refrigerant leaving the condenser is then directed to an expansion valve which reduces the pressure and creates a lower pressure refrigerant liquid which has a temperature below the temperature of outdoor ambient air. The cold liquid refrigerant leaving the expansion device is directed to the outdoor evaporator, and in the heating mode the cold refrigerant liquid absorbs heat to produce refrigerant vapor, which is directed by the reversing valve to the suction side of the compressor. In a typical arrangement, both the compressor and the evaporator are located outside of the residence, while the condenser is located inside the residence.

To evaluate cold climate performance using refrigerants of the present invention, an evaporating temperature of −30° C. was selected and the condensing temperature may vary between 30° C. and 60° C., but a temperature of 40° C. was selected.

### Operating Conditions

Condensing temperature=40° C., Corresponding air discharge temperature=32° C.
Condenser sub-cooling=5° C.
Evaporating temperature=−30° C., Corresponding outdoor ambient temperature=−25° C.
Evaporator Superheat=5° C.
Isentropic Efficiency=65%
Cycle Components: Compressor, condenser, expansion device and evaporator
The results are reported in Table Ex1 below.

TABLE Ex1

| Fluid | Capacity | | COP | | Capacity* | Effective | |
|---|---|---|---|---|---|---|---|
| Com- | Rela- | Rela- | Rela- | Rela- | LFL/rho_1 | glide | |
| po- | tive | tive to | tive | tive to | Relative | Eva- | Con- |
| sition | to R290 | R410A | to R290 | R410A | to R290 | porator | denser |
| ExA | 131.9% | 77.3% | 99.0% | 101.8% | 158.0% | 0.7 | 1.0 |
| ExB | 132.8% | 77.8% | 98.9% | 101.7% | 156.4% | 0.7 | 1.3 |
| ExC | 129.1% | 75.6% | 99.4% | 102.2% | 162.3% | 1.8 | 1.4 |
| ExD | 139.6% | 81.8% | 98.9% | 101.6% | 176.4% | 1.6 | 1.5 |

The COP of refrigerants ExA-ExD have about 0.6-1.1% lower values compared to R290, however the capacities are 29.1-40.0% greater. This is an important but unexpected advantage because in cold climate applications it is important to deliver the required capacity without the need for auxiliary heating. Thus, the refrigerants of the present invention provide greater capacities, which allows this requirement to be achieved with lower system cost, while possibly resulting in a higher overall system efficiency when accounting for the auxiliary heating.

The Capacity*LFL/rho_1 represents the capacity delivered within the flammable charge allowed accounting for the refrigerant's density to define how much charge a system would require. This metric was devised to easily compare estimates on how much capacity a refrigerant would provide while keeping the system within the charge constraints of flammable refrigerants. This metric shows a significant and unexpected improvement over propane (R-290).

### Example 2—Cold Climate Air to Water Heat Pumps

This example illustrates cold climate air to water heat pumps of the type illustrated generally in FIG. 2B, such as mono-block heat pumps, heat pump chillers or any heat pump systems that use the external air as a heat source for its evaporator and heats a secondary fluid, such as water, another refrigerant or a brine, which is then used to heat the building. To evaluate its cold climate performance an evaporating temperature of −30° C. was selected and the condensing temperature may vary between 35° C. and 70° C., but a temperature of 60° C. was selected.

### Operating Conditions

1. Condensing temperature=60° C., Corresponding water discharge temperature=55° C.
2. Condenser sub-cooling=5° C.
3. Evaporating temperature=−30° C., Corresponding outdoor ambient temperature=−25° C.
4. Evaporator Superheat=5° C.
5. Isentropic Efficiency=65%

### Cycle Components

### Compressor, Condenser, Expansion Device and Evaporator

The results are reported in Table Ex2 below.

TABLE Ex2

| | | | | | Capacity* | | |
|---|---|---|---|---|---|---|---|
| Fluid | Capacity | | COP | | LFL/rho_1 | Effective | |
| Com- | Rela- | Rela- | Rela- | Rela- | Rela- | glide | |
| po- | tive | tive to | tive to | tive to | tive to | Eva- | Con- |
| sition | to R290 | R410A | R290 | R410A | R290 | porator | denser |
| ExA | 132.2% | 77.0% | 99.0% | 102.8% | 161.5% | 0.5 | 0.9 |
| ExB | 132.7% | 77.3% | 98.6% | 102.4% | 159.4% | 0.5 | 1.1 |
| ExC | 130.3% | 75.9% | 100.1% | 103.9% | 166.6% | 1.5 | 1.1 |
| ExD | 140.3% | 81.7% | 99.0% | 102.8% | 181.3% | 1.3 | 1.2 |

Unexpected advantages similar to those described in connection with Example 1 are achieved.

### Example 3—Mild Climate Air to Air Heat Pumps

This example illustrates mild climate air to air heat pump systems, of the type illustrated generally in FIG. 2B, such as mini-split systems, rooftop systems, central heat pump systems, and any heat pump system that uses the external air as a heat source for its evaporator and heats the indoor air flow through its condenser. To evaluate its mild climate performance an evaporating temperature of 0° C. was selected and the condensing temperature may vary between 30° C. and 60° C., but a temperature of 40° C. was selected.

### Operating Conditions

1. Compositions condensing temperature=40° C., Corresponding air discharge temperature=33° C.
2. Condenser sub-cooling=5° C.
3. Evaporating temperature=0° C., Corresponding outdoor ambient temperature=7° C.
4. Evaporator Superheat=5° C.
5. Isentropic Efficiency=70%

### Cycle Components

### Compressor, Condenser, Expansion Device and Evaporator

The results are reported in Table Ex3 below.

TABLE Ex3

| | | | | | Capacity* | | |
|---|---|---|---|---|---|---|---|
| Fluid | Capacity | | COP | | LFL/rho_1 | Effective | |
| Com- | Rela- | Rela- | Rela- | Rela- | Rela- | glide | |
| po- | tive | tive to | tive to | tive to | tive to | Eva- | Con- |
| sition | to R290 | R410A | R290 | R410A | R290 | porator | denser |
| ExA | 130.1% | 75.1% | 98.4% | 102.5% | 155.8% | 0.8 | 1.0 |
| ExB | 130.4% | 75.3% | 98.3% | 102.4% | 153.6% | 0.9 | 1.3 |
| ExC | 129.3% | 74.7% | 98.8% | 102.9% | 162.6% | 1.6 | 1.4 |
| ExD | 138.1% | 79.7% | 98.1% | 102.2% | 174.4% | 1.5 | 1.5 |

Unexpected advantages similar to those described in connection with Example 1 are achieved.

### Example 4—Mild Climate Air to Water Heat Pumps

This example illustrates mild climate air to water heat pumps, of the type illustrated generally in FIG. 2B, such as mono-block heat pumps, heat pump chillers or any heat pump systems that use the external air as a heat source for its evaporator and heats a secondary fluid, such as water, another refrigerant or a brine, which is then used to heat the building. To evaluate its mild climate performance an evaporating temperature of 0° C. was selected and the condensing temperature may vary between 35° C. and 70° C., but a temperature of 60° C. was selected.

### Operating Conditions

1. Compositions condensing temperature=60° C., Corresponding water outlet temperature=55° C.
2. Condenser sub-cooling=5° C.
3. Evaporating temperature=0° C., Corresponding outdoor ambient temperature=7° C.
4. Evaporator Superheat=5° C.
5. Isentropic Efficiency=70%

### Cycle Components

### Compressor, Condenser, Expansion Device and Evaporator

The results are reported in Table Ex4 below.

TABLE Ex4

| | | | | | Capacity* | | |
|---|---|---|---|---|---|---|---|
| Fluid | Capacity | | COP | | LFL/rho_1 | Effective | |
| Com- | Rela- | Rela- | Rela- | Rela- | Rela- | glide | |
| po- | tive | tive to | tive to | tive to | tive to | Eva- | Con- |
| sition | to R290 | R410A | R290 | R410A | R290 | porator | denser |
| ExA | 129.9% | 75.5% | 97.9% | 104.5% | 158.5% | 0.7 | 1.0 |
| ExB | 129.8% | 75.5% | 97.5% | 104.1% | 155.8% | 0.7 | 1.3 |
| ExC | 130.2% | 75.7% | 98.9% | 105.6% | 166.5% | 1.8 | 1.4 |
| ExD | 138.2% | 80.3% | 97.6% | 104.2% | 178.5% | 1.6 | 1.5 |

Unexpected advantages similar to those described in connection with Example 1 are achieved.

### Example 5—Water/Brine to Air Heat Pumps

This example illustrates mild climate water/brine to air heat pump systems, of the type illustrated generally in FIG. 2B, such as ground-source heat pumps or any heat pump system that uses a secondary fluid in liquid or two-phase state as a heat source for its evaporator and heats the indoor air flow through its condenser. To evaluate its performance an evaporating temperature of 5° C. was selected and the condensing temperature may vary between 30° C. and 60° C., but a temperature of 40° C. was selected.

### Operating Conditions

1. Compositions condensing temperature=40° C., Corresponding air discharge temperature=33° C.
2. Condenser sub-cooling=5° C.
3. Evaporating temperature=5° C., Corresponding water/brine evaporator inlet temperature=12° C.
4. Evaporator Superheat=5° C.
5. Isentropic Efficiency=70%

### Cycle Components

### Compressor, Condenser, Expansion Device and Evaporator

The results are reported in Table Ex5 below.

TABLE Ex5

| | Capacity | | | COP | | | Capacity | | |
|---|---|---|---|---|---|---|---|---|---|
| Fluid | | Relative | Relative | Relative | Relative | Relative | *LFL/rho_1 | Effective glide | |
| Com- | Relative | to | to | to | to | to | Relative to | Evapor- | Conden- |
| position | to R290 | R410A | R134a | R290 | R410A | R134a | R290 | ator | ser |
| ExA | 129.8% | 74.8% | 171.5% | 98.4% | 102.6% | 97.1% | 155.5% | 0.8 | 1.0 |
| ExB | 130.1% | 75.0% | 172.0% | 98.2% | 102.5% | 96.9% | 153.3% | 1.0 | 1.3 |
| ExC | 129.2% | 74.5% | 170.8% | 98.7% | 103.0% | 97.4% | 162.6% | 1.5 | 1.4 |
| ExD | 137.8% | 79.4% | 182.1% | 98.0% | 102.3% | 96.7% | 174.1% | 1.5 | 1.5 |

### Example 6—Water/Brine to Water Heat Pumps

This example illustrates mild climate water/brine to water heat pumps, of the type illustrated generally in FIG. 2B, such as ground-source heat pumps or any heat pump systems that use a secondary fluid in liquid or two-phase state as a heat source for its evaporator and heats a secondary fluid, such as water, another refrigerant or a brine, which is then used to heat the building. To evaluate its mild climate performance an evaporating temperature of 5° C. was selected and the condensing temperature may vary between 35° C. and 70° C., but a temperature of 60° C. was selected.

### Operating Conditions

1. Compositions condensing temperature=60° C., Corresponding water outlet temperature=55° C.
2. Condenser sub-cooling=5° C.
3. Evaporating temperature=5° C., Corresponding water source temperature=15° C.
4. Evaporator Superheat=5° C.
5. Isentropic Efficiency=70%

### Cycle Components

### Compressor, Condenser, Expansion Device and Evaporator

The results are reported in Table Ex6 below.

TABLE Ex 6

| | | | | | | | Capacity | | |
|---|---|---|---|---|---|---|---|---|---|
| | Capacity | | | COP | | | *LFL/rho_1 | | |
| Fluid | Relative | Relative | Relative | Relative | Relative | Relative | Relative | | |
| Com- | to | to | to | to | to | to | to | Effective glide | |
| position | R290 | R410A | R134a | R290 | R410A | R134a | R290 | Evaporator | Condenser |
| ExA | 129.5% | 75.3% | 170.6% | 97.7% | 104.8% | 95.8% | 158.1% | 0.6 | 0.9 |
| ExB | 129.3% | 75.2% | 170.4% | 97.3% | 104.4% | 95.5% | 155.3% | 0.7 | 1.1 |
| ExC | 130.0% | 75.7% | 171.4% | 98.7% | 105.9% | 96.8% | 166.3% | 1.2 | 1.1 |
| ExD | 137.7% | 80.1% | 181.5% | 97.4% | 104.4% | 95.5% | 178.0% | 1.2 | 1.2 |

### Example 7—Domestic Hot Water Heat Pumps

This example illustrates domestic hot water heat pumps, of the type illustrated generally in FIG. 2B, which may use outdoor or indoor air as a heat source, or may use water as a heat source, such as sewage, to heat up domestic hot water to be used in a building. To evaluate its performance an evaporating temperature of 10° C. was selected and the condensing temperature may vary between 55° C. and 80° C., but a temperature of 70° C. was selected.

### Operating Conditions

1. Compositions condensing temperature=70° C., Corresponding water outlet temperature=65° C.
2. Condenser sub-cooling=5° C.
3. Evaporating temperature=10° C.
4. Evaporator Superheat=5° C.
5. Isentropic Efficiency=70%

### Cycle Components

### Compressor, Condenser, Expansion Device and Evaporator

The results are reported in Table Ex7 below.

TABLE Ex7

| | | | | | | | Capacity | | |
|---|---|---|---|---|---|---|---|---|---|
| | Capacity | | | COP | | | *LFL/rho_1 | | |
| Fluid | Relative | Relative | Relative | Relative | Relative | Relative | Relative | | |
| Com- | to | to | to | to | to | to | to | Effective glide | |
| position | R290 | R410A | R134a | R290 | R410A | R134a | R290 | Evaporator | Condenser |
| ExA | 128.7% | 76.1% | 164.7% | 96.9% | 107.4% | 94.5% | 159.5% | 0.5 | 0.7 |
| ExB | 128.1% | 75.8% | 164.1% | 96.3% | 106.8% | 93.9% | 156.4% | 0.6 | 1.0 |
| ExC | 130.3% | 77.0% | 166.8% | 98.4% | 109.1% | 95.9% | 168.8% | 1.1 | 0.9 |
| ExD | 137.0% | 81.0% | 175.4% | 96.4% | 106.9% | 94.0% | 180.4% | 1.1 | 1.0 |

### Example 8—Tumble Dryer and Other Small Appliance Heat Pumps

This example illustrates tumble dryers and other small appliances, such as dishwashers and portable heat pumps which may use outdoor or indoor air as a heat source, or may use water as a heat source, such as sewage, to provide heat for small appliance applications. To evaluate its performance an evaporating temperature of 15° C. was selected and the condensing temperature may vary between 55° C. and 80° C., but a temperature of 50° C. was selected.

### Operating Conditions

1. Compositions condensing temperature=50° C.
2. Condenser sub-cooling=5° C.
3. Evaporating temperature=15° C.
4. Evaporator Superheat=5° C.
5. Isentropic Efficiency=70%

### Cycle Components

### Compressor, Condenser, Expansion Device and Evaporator

The results are reported in Table Ex8 below.

TABLE Ex8

| | Capacity | | COP | | Capacity* | | |
|---|---|---|---|---|---|---|---|
| Fluid | Rela- | Rela- | Rela- | Rela- | LFL/ | Effective | |
| Com- | tive | tive | tive | tive | rho_1 | glide | |
| po- | to | to | to | to | Relative | Evapo- | Con- |
| sition | R290 | R134a | R290 | R134a | to R290 | rator | denser |
| ExA | 129.0% | 162.2% | 97.8% | 96.1% | 155.8% | 0.6 | 0.9 |
| ExB | 129.1% | 162.3% | 97.6% | 95.9% | 153.3% | 0.7 | 1.1 |
| ExC | 129.3% | 162.6% | 98.4% | 96.6% | 163.8% | 1.3 | 1.1 |
| ExD | 137.1% | 172.4% | 97.4% | 95.7% | 174.9% | 1.2 | 1.2 |

### Example 9—Medium Temperature Refrigeration System Performance

### Operating Conditions

1. Condensing temperature=45° C.
2. Condenser sub-cooling=0° C.
3. Evaporating temperature=−8° C.
4. Evaporator Superheat=5.5° C.
5. Suction line temperature rise=10° C.
6. Isentropic Efficiency=65%

The results are reported in Table Ex9 below.

TABLE Ex9

| | Capacity | | COP | | Capacity* | | |
|---|---|---|---|---|---|---|---|
| Fluid | Rela- | Rela- | Rela- | Rela- | LFL/rho_1 | Effective | |
| Com- | tive | tive | tive | tive | Relative | glide | |
| po- | to | to | to | to | to | Evapo- | Con- |
| sition | R290 | R404A | R290 | R404A | R290 | rator | denser |
| ExA | 129.1% | 115.7% | 97.5% | 111.7% | 156.2% | 0.7 | 1.0 |
| ExB | 129.2% | 115.8% | 97.1% | 111.2% | 153.7% | 0.7 | 1.3 |
| ExC | 128.9% | 115.5% | 98.7% | 113.0% | 163.5% | 1.5 | 1.3 |
| ExD | 136.9% | 122.7% | 97.2% | 111.3% | 175.0% | 1.4 | 1.5 |

### Example 10—Low Temperature Refrigeration System Performance

### Operating Conditions

1. Condensing temperature=45° C.
2. Condenser sub-cooling=0° C.
3. Evaporating temperature=−35° C.
4. Evaporator Superheat=5.5° C.
5. Suction line temperature rise=10° C.
6. Isentropic Efficiency=65%

The results are reported in Table Ex10 below.

TABLE Ex10

| | | | | | Capacity | | |
|---|---|---|---|---|---|---|---|
| | Capacity | | COP | | *LFL/ | | |
| Fluid | Rela- | Rela- | Rela- | Rela- | rho_1 | Effective | |
| Com- | tive | tive | tive | tive | Relative | glide | |
| po- | to | to | to | to | to | Evapo- | Con- |
| sition | R290 | R404A | R290 | R404A | R290 | rator | denser |
| ExA | 131.1% | 129.7% | 98.3% | 118.2% | 158.6% | 0.6 | 1.0 |
| ExB | 131.6% | 130.2% | 97.9% | 117.6% | 156.6% | 0.5 | 1.3 |
| ExC | 129.1% | 127.7% | 99.9% | 120.1% | 163.7% | 1.7 | 1.3 |
| ExD | 138.7% | 137.2% | 98.4% | 118.2% | 177.3% | 1.5 | 1.5 |

### Example 11—Mobile Low Ambient Heat Pump Performance (Heating Mode)

### Operating Conditions

1. Condensing temperature=65° C.
2. Condenser sub-cooling=5° C.
3. Evaporating temperature=−40° C.
4. Evaporator Superheat=5° C.
5. Suction line temperature rise=5° C.
6. Isentropic Efficiency=65%

The results are reported in Table Ex11 below.

TABLE Ex11

| Fluid | Capacity | COP | | Effective glide | |
|---|---|---|---|---|---|
| Compo- | Relative | Relative | Capacity*LFL/rho_l | Evapo- | Con- |
| sition | to R290 | to R290 | Relative to R290 | rator | denser |
| ExA | 132.2% | 99.1% | 162.6% | 0.5 | 0.8 |
| ExB | 133.1% | 98.7% | 161.0% | 0.4 | 1.1 |
| ExC | 128.9% | 100.4% | 165.8% | 1.4 | 1.0 |
| ExD | 139.7% | 99.2% | 182.0% | 1.3 | 1.1 |

### Example 12—Mobile High Ambient Heat Pump Performance (Cooling Mode)

### Operating Conditions

1. Condensing temperature=45° C.
2. Condenser sub-cooling=5° C.
3. Evaporating temperature=5° C.
4. Evaporator Superheat=5° C.
5. Suction line temperature rise=5° C.
6. Isentropic Efficiency=65%

The results are reported in Table Ex12 below.

TABLE Ex12

| Fluid | Capacity | COP | | Effective glide | |
|---|---|---|---|---|---|
| Compo- | Relative | Relative | Capacity*LFL/rho_l | Evapo- | Con- |
| sition | to R290 | to R290 | Relative to R290 | rator | denser |
| ExA | 128.8% | 97.6% | 154.9% | 0.8 | 1.0 |
| ExB | 129.0% | 97.3% | 152.5% | 0.9 | 1.3 |
| ExC | 128.7% | 98.2% | 162.4% | 1.5 | 1.3 |
| ExD | 136.7% | 97.1% | 173.4% | 1.5 | 1.5 |

### Example 13—Air Conditioning (Air-Air, Central or Split System)

### Operating Conditions

1. Condensing temperature=45° C.
2. Condenser sub-cooling=5° C.
3. Evaporating temperature=8° C.
4. Evaporator Superheat=5° C.
5. Isentropic Efficiency=70%

### Cycle Components

### Compressor, Condenser, Expansion Device and Evaporator

The results are reported in Table Ex13 below.

TABLE 13
Composition of interest performance in air-air air conditioning systems

| | Capacity | | COP | | Capacity* | | |
|---|---|---|---|---|---|---|---|
| Fluid | Rela- | Rela- | Rela- | Rela- | LFL/rho_1 | Effective | |
| Com- | tive | tive | tive | tive | Relative | glide | |
| po- | to | to | to | to | to | Evapo- | Con- |
| sition | R290 | R410A | R290 | R410A | R290 | rator | denser |
| ExA | 129.0% | 75.2% | 97.8% | 103.9% | 155.1% | 0.8 | 1.0 |
| ExB | 129.2% | 75.3% | 97.5% | 103.7% | 152.7% | 1.0 | 1.3 |
| ExC | 128.9% | 75.2% | 98.3% | 104.5% | 162.7% | 1.4 | 1.3 |
| ExD | 136.9% | 79.8% | 97.3% | 103.4% | 173.8% | 1.5 | 1.5 |

### Example 14—Air Conditioning Chillers (Air-Water, Residential Monobloc/Split, Commercial)

### Operating Conditions

1. Condensing temperature=45° C.
2. Condenser sub-cooling=5° C.
3. Evaporating temperature=4° C.
4. Evaporator Superheat=5° C.
5. Isentropic Efficiency=70%

### Cycle Components

### Compressor, Condenser, Expansion Device and Evaporator

The results are reported in Table Ex14 below.

TABLE Ex14

| | | | | | | | Capacity* | | |
|---|---|---|---|---|---|---|---|---|---|
| | Capacity | | | COP | | | LFL/rho_1 | | |
| Fluid | Relative | Relative | Relative | Relative | Relative | Relative | Relative | Effective glide | |
| Com- | to | to | to | to | to | to | to | Evapo- | Con- |
| position | R290 | R410A | R432 | R290 | R410A | R32 | R290 | rator | denser |
| ExA | 129.2% | 75.5% | 104.5% | 97.8% | 103.8% | 111.0% | 155.4% | 0.8 | 1.0 |
| ExB | 129.4% | 75.6% | 104.6% | 97.6% | 103.6% | 110.8% | 152.9% | 0.9 | 1.3 |
| ExC | 129.0% | 75.4% | 104.3% | 98.4% | 104.5% | 111.7% | 162.8% | 1.5 | 1.3 |
| ExD | 137.1% | 80.1% | 110.9% | 97.4% | 103.4% | 110.5% | 174.0% | 1.5 | 1.5 |

What is claimed is:

1. A refrigerant comprising:
a. from about 16% to about 35% by weight of HFO-1132 (E);
b. from about 32% to about 52% by weight of HFC-161; and
c. from about 42% to about 60% by weight of R-290.

2. The refrigerant of claim 1 consisting essentially of:
a. from about 16% to about 35% by weight of HFO-1132 (E);
b. from about 32% to about 52% by weight of HFC-161; and
c. from about 42% to about 60% by weight of R-290.

3. The refrigerant of claim 1 consisting of:
a. from about 16% to about 35% by weight of HFO-1132 (E);
b. from about 32% to about 52% by weight of HFC-161; and
c. from about 42% to about 60% by weight of R-290.

4. The refrigerant of claim 1 wherein said refrigerant has a Global Warming Potential (GWP) of 50 or less.

5. The refrigerant of claim 1 wherein said refrigerant has (i) a Global Warming Potential (GWP) of 35 or less.

6. A method of heating comprising condensing a refrigerant according to claim 1.

7. A method of cooling comprising evaporating a refrigerant according to claim 1.

8. A heat pump comprising a refrigerant according to claim 1.

9. An air conditioner comprising a refrigerant according claim 1.

10. A mobile air conditioner comprising a refrigerant according to claim 1.

11. A low temperature refrigeration system comprising a refrigerant according to claim 1.

12. A medium temperature refrigeration system comprising a refrigerant according claim 1.

13. A heat transfer composition comprising:
a. refrigerant comprising:
i. from about 16% to about 35% by weight of HFO-1132 (E);
ii. from about 32% to about 52% by weight of HFC-161; and
iii. from about 42% to about 60% by weight of R-290; and
b. at least one lubricant.

14. The heat transfer composition of claim 13 wherein said lubricant comprises a PVE lubricant.

15. The heat transfer composition of claim 13 wherein said lubricant comprises a POE lubricant.

16. A heat pump comprising a heat transfer composition of claim 13.

17. A method for replacing the refrigerant in a heat transfer system containing or designed to contain R-290, said method comprising using, instead of R-290, in said heat transfer system a refrigerant comprising:
i. from about 16% to about 35% by weight of HFO-1132 (E);
ii. from about 32% to about 52% by weight of HFC-161; and
iii. from about 42% to about 60% by weight of R-290.

18. The method of claim 17 wherein said refrigerant operating in said system has a capacity of at least about 120% of the capacity of R-290 operating in said system.

19. The method of claim 18 wherein said heat transfer system is a heat pump.

20. The method of claim 18 wherein said heat transfer system is a residential heat pump.
